(19) United States
(12) Patent Application Publication
(10) Pub. No.: US 2014/0014571 A1
(43) Pub. Date: Jan. 16, 2014

(54) SPORTS BOTTLE TOP WITH AXIAL FLOW FILTER DEVICE

(71) Applicants: Steven D. Nelson, Buena Park, CA (US); Christian Michael Olsen, Salt Lake City, UT (US)

(72) Inventors: Steven D. Nelson, Buena Park, CA (US); Christian Michael Olsen, Salt Lake City, UT (US)

(73) Assignee: FIT SYSTEMS, LLC, Reno, NV (US)

(21) Appl. No.: 13/546,781

(22) Filed: Jul. 11, 2012

(51) Int. Cl. B01D 29/92; B65D 51/24

(52) U.S. Cl. 210/468; 215/387; 215/228

(57) ABSTRACT

A sports bottle top filter with a mounting flange, downwardly depending barrel, having a sleeve telescoped thereto and mounting on its lower extremity a filter holder configured to engage a tray mounted on the bottom of the barrel and a seal interposed between the holder and tray to seal against flow from the container through openings in the tray back into a filter held by the holder.

### BACKGROUND

1. Field of the Invention

The field of the invention relates to sports bottles and particularly to sports bottles incorporating filters for filtering tap water and the like.

2. Description of the Prior Art

With the active healthy way of life subscribed to by many in society, a great demand exists for personal sports bottles for carrying a quantity of refreshing or energizing liquid for quick hydration during sporting activities such as running, bicycling, hiking, tennis, golf and the like. Typically, sports bottles are constructed of plastic, a material often not biodegradable and, with the relatively high consumption at today's rates, the landfills are fast filling with single use bottles.

It has long been recognized that the cost and inconvenience of accessing filtered water is a problem which can discourage consumption of sufficient quantities of fluids to adequately hydrate the athlete. Accordingly, there has long existed a need for a compact and convenient filtration device which would allow for use of readily available tap water to be conveniently and inexpensively introduced and filtered allowing for numerous repeated fills and a long service life.

Numerous different efforts have been made to provide different types of filtration systems for filtering drinking water and the like. Early on, a canteen was proposed which was separated into multiple chambers and including a filtering body interposed between the chambers so that an air pump could force unfiltered water through the filtering body. A device of this type is shown in U.S. Pat. No. 7,036,542 to Hall.

Another device proposed for use in conjunction with a canteen involved an internal chamber filled with a particulate material for purifying the water and incorporating concentric tubes to force the fluid to flow through a circuitous path, and also including a manually operated pump for pressurizing the container to pump the water from the canteen through the purifying assembly. A device of this type is shown in U.S. Pat. No. 4,714,550 to Malson.

Another example of a prior water purification system is disclosed as a container with a removable lid positioned within a wide mouth tubular structure and including a filter cartridge positioned centrally to divide the container into two compartments for unfiltered water and filtered water. The filtering material includes a macro fabric filter, a core of silver-impregnated granular activated carbon, and a bottom segment of macro fabric filter to remove contaminants and sediments from the water percolated through the disposable filter cartridge to thereby improve the taste of the water and remove odors before being drawn from a spigot at the bottom of the container. A device of this type is shown in U.S. Pat. No. 4,800,018 to Moser.

Another proposed solution involves a container receiving an elongated filter device and a sipping through which drinking water may be drawn by a partial vacuum as air is vented into the container. A device of this type is shown in U.S. Pat. No. 5,122,272 to Iana. While suitable for some applications such devices have not generally been accepted as athletes usually prefer to have filtered water readily available in high volumes without the necessity of drawing through a filter under influence of oral application of a negative pressure to withdraw the water.

Other constructions incorporating upper and lower chambers separated by a filter includes the proposal of a ceramic filter through which water is dripped under gravitational forces from an upper to a lower receptacle. A device of this type is shown in U.S. Pat. No. 5,186,830 to Rait.

It has also been proposed to incorporate filtering devices in the neck of a water bottle to filter pesticides, chlorine, particulate matter, algae, bacteria and heavy metals from the water to improve the taste and remove odors. A device of this type is shown in U.S. Pat. No. 5,431,813 to Daniels. Similar cap adapters have been proposed with filters through which tap water in the container may be filtered by the athlete drawing on the discharge spout, a device of this type is shown in U.S. Pat. No. 7,993,518 to Shani.

Another approach proposed is a tubular filter in a container deferring a central inlet flow passage through a one way valve for introduction of tap water to then hopefully flow radially inwardly through the tubular wall of the filter to be discharged out a mouthpiece, a device of this type is shown in U.S. Pat. No. 6,395,170 to Hughes. While, indeed, providing for filtration, such devices inherently pressure differential across the wall and the tubular filters and are plagued with slow flow unacceptable to the thirsty athlete.

Another proposed solution involves a container including a porous filter cartridge sealed in an outlet port and incorporating multiple fibrous spacers and treatment chambers containing beds of treatment media to filter the water for storage in the container as dispensed via outlet ports in the periphery of the purifier cartridge. A device of this type is shown in U.S. Pat. No. 5,562,824 to Magnusson.

Another plastic bottle device includes a neck for receiving a tube of filtering material for filtering water introduced through the neck. A device of this type is shown in U.S. Pat. No. 5,609,759 to Nohren, Jr.

Numerous different types of squeeze bottles have been proposed for use with various types of filters for creating partial vacuums within the chambers to draw water through filters or to pressurize and expel water from the bottle. One such type is shown in U.S. Pat. No. 5,733,448 to Kura. Another squeeze bottle approach was proposed with a cylindrical filter housing mounted to a top flange and housing a floating filter intended to, when upright create an annular flow path to bypass the filter with tap water but when mounted, block such flow to direct the unfiltered water through the filter as it exits, a device of this type is shown in U.S. Pat. No. 5,9149,365 to Collette. Again, filtration at the exit is typically unsatisfactory as it restricts flow.

Other bottles have been proposed which include an enlarged wide-mouth neck for receiving a filter through which unfiltered water can be poured and through which is passed a relatively rigid straw for drawing filtered water from the bottom of the bottle. A device of this type is shown in U.S. Pat. No. 5,497,920 to Moeller.

It has also been proposed to provide a water pitcher including an inner chamber for containing unfiltered water to be flowed through a bottom outlet plugged by a filter to provide filtered water to be drawn out through a spout. A device of this type is shown in U.S. Pat. No. 7,670,479 to Arett.

It has also been proposed to provide a bottle with an inverted bottom with the bottom thereof being open for receipt of a filter device including a screen and filter through which water might be passed to be retained in the bottle for subsequent consumption from the neck of the bottle itself. A device of this type is shown in U.S. Patent Publication No. 2010/0170839 published Jul. 8, 2010 to Kohl.

Other proposals have suggested a bottle formed intermediately with a wall for suspending a filter and having an inlet stub in the shoulder of its upper portion for receiving unfiltered water to pass through the filter and to subsequently be dispensed therefrom when the bottle is inverted for the filtered water to flow through an annulus in the wall of the bottle to be dispensed through the neck of the bottle. A device of this type is shown in U.S. Pat. No. 6,733,669 to Crick.

A multi-stage water purification device has been proposed including a lower compartment having a flexible wall which may be compressed and then released to draw a partial vacuum to thus draw unfiltered water downwardly from an overhead compartment through a multi-stage filter to be partially filtered and stored in the lower compartment so that upon subsequent compression of the flexible wall the partially filtered water will be driven upwardly through a one-way valve to pass through a second stage filter to a filtered water compartment ready to be discharged through a pull up valve. A device of this type is shown in U.S. Pat. No. 7,585,409 to Bommi et al. Such devices are relatively complicated, expensive to manufacture and possesses a relatively low flow rate for filtering of the water.

The invention may be embodied in other forms without departure from the spirit and essential characteristics thereof. The embodiments described therefore are to be considered in all respects as illustrative and not restrictive. Although the present invention has been described in terms of certain preferred embodiments, other embodiments that are apparent to those of ordinary skill in the art are also within the scope of the invention. Accordingly, the scope of the invention is intended to be defined only by reference to the appended claims.

### SUMMARY OF THE INVENTION

In one aspect of the present invention the device is in the form of a lid or cap for a sports bottle which includes a mounting flange having a depending barrel mounting, a tray is mounted at the lower extremity is formed in the peripheral walls with outlets. A sleeve is received in the barrel and includes at the lower extremity a peripheral valve element which, when registered with the openings serves to block the outlets. The sleeve may mount a filter for flow there-through of tap water. A plug is provided for plugging the top of the sleeve and is removable so that tap water can be poured through the sleeve, through the filter and out the peripheral outlets.

In another aspect, a plug plugging the sleeve mounts a lever arm carrying a stop on the free end thereof for selective positioning over a pour spout formed in the flange adjacent the barrel.

In another aspect, the stop is shiftable laterally on the sleeve to open the sleeve for flow of water and the stop may act as a finger grip device.

### BRIEF DESCRIPTION OF THE DRAWINGS

FIG. 1 is perspective view of a sports bottle mounting a cap incorporating the present invention;

FIG. 2 is a top plan view of the device shown in FIG. 1;

FIG. 3 is a partial perspective view similar to FIG. 1 but showing the sleeve raised and the stop open;

FIG. 4 is a vertical sectional view, in enlarged scale, taken along the lines 4-4 of FIG. 1;

FIG. 5 is a vertical sectional view taken along the lines 5-5 of FIG. 4;

FIG. 6 is a transverse sectional view taken along the lines of 6-6 of FIG. 5;

FIG. 7 is a transverse sectional view similar to FIG. 6 but showing the stop shifted laterally out of alignment with the sleeve;

FIG. 8 is a transverse sectional view taken along lines 8-8 of FIG. 4;

FIG. 9 is a partial vertical sectional view taken along the lines 9-9 of FIG. 8;

FIG. 10 is a transverse sectional view taken along the lines 10-10 of FIG. 4;

FIG. 11 is a transverse sectional view taken along the line 11-11 of FIG. 14;

FIG. 12 is a transverse sectional view taken along the lines of 12-12 of FIG. 4;

FIG. 13 is a transverse sectional view taken along the lines 13-13 of FIG. 12;

FIG. 14 is a vertical sectional view similar to FIG. 4 but showing the sleeve in its elevated position; and

FIG. 15 is partial vertical sectional view similar to FIG. 14 but showing flow out the pour spout.

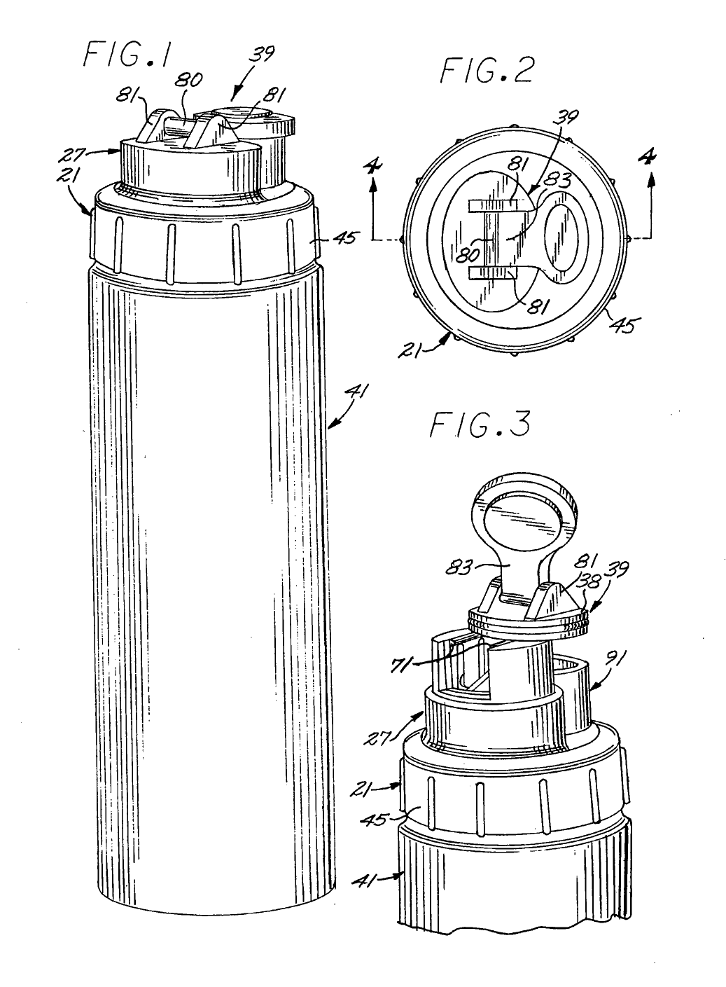

### DETAILED DESCRIPTION OF THE PREFERRED EMBODIMENTS

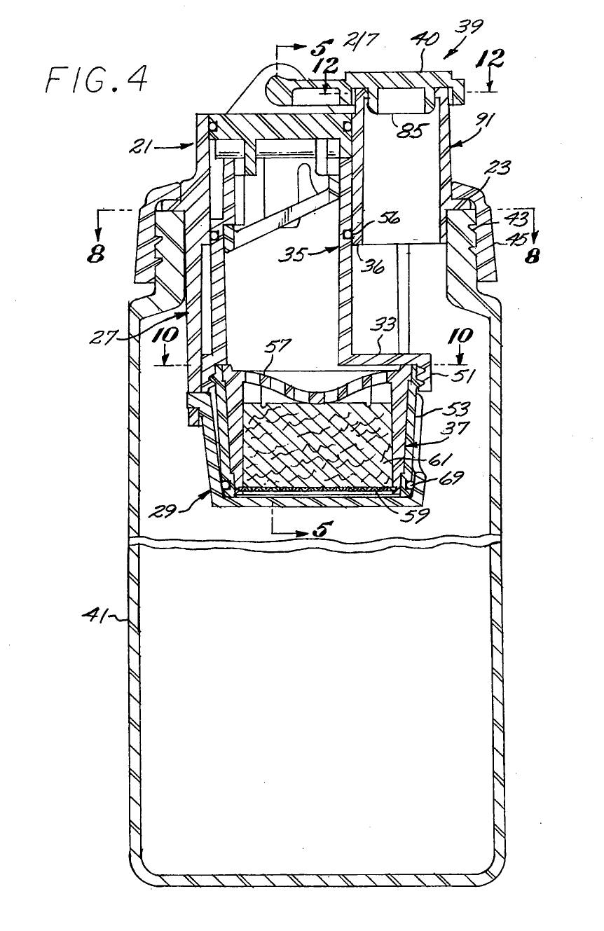

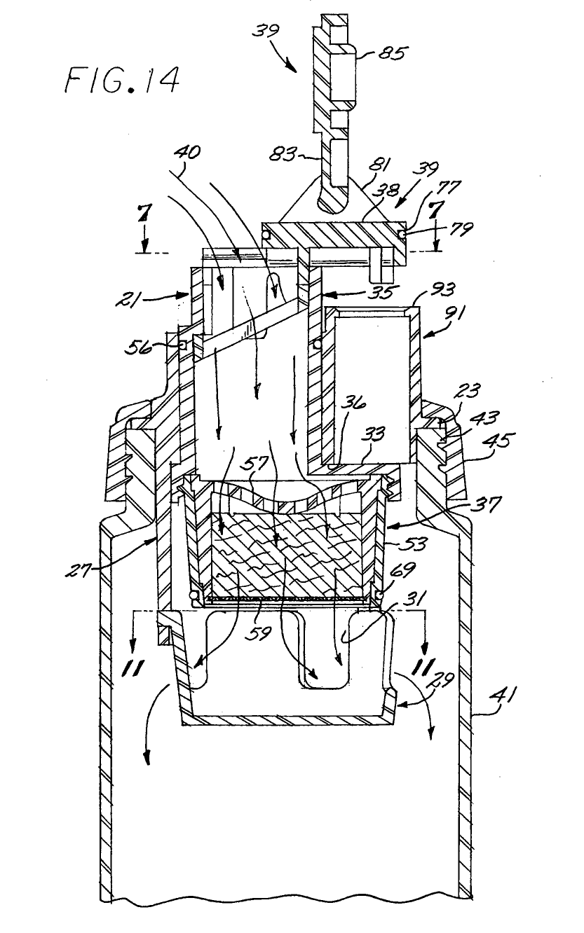

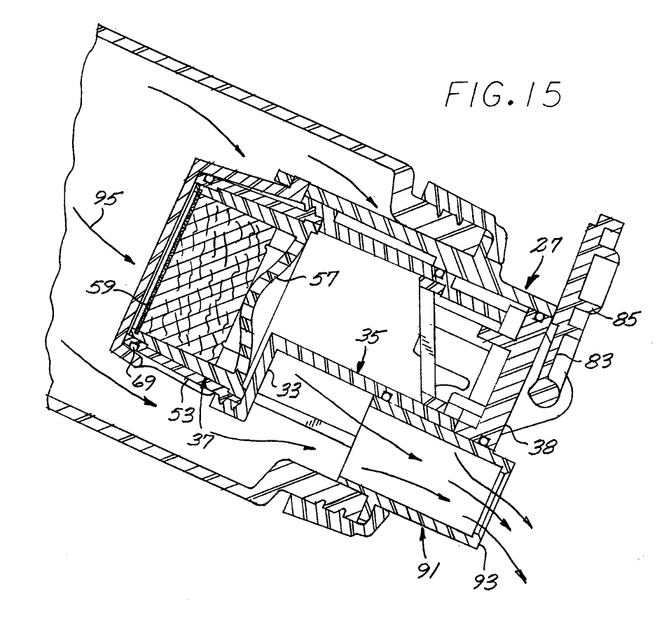

Referring to FIGS. 3, 4 and 15, the sports bottle filtration cap of the present invention includes, generally, a cap device 21 including a mounting flange 23 formed with a depending barrel 27 carrying on its lower extremity an inverted hat shaped tray 29 formed in its peripheral wall with a plurality of vertically elongated outlets 31 (FIG. 14). A sleeve, generally designated 35 is received slidably in the barrel and carries a cup shaped holder 53 at its lower extremity to mount a filter basket 37. The holder 53 is formed in its lower extremity with an O-ring gland mounting an O-ring 69 to seal against the holder as shown in FIG. 4.

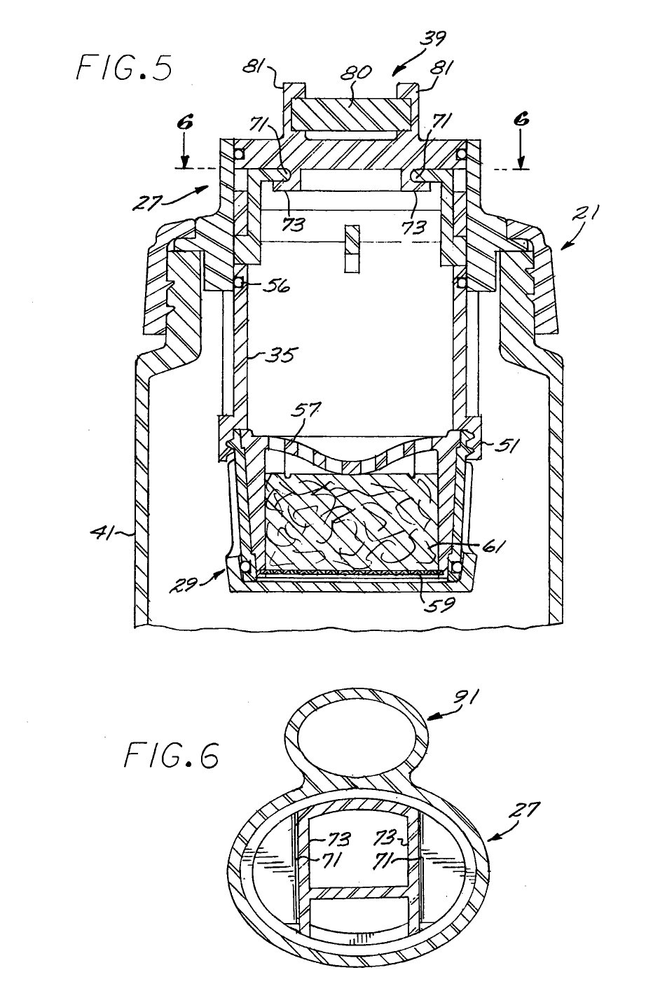

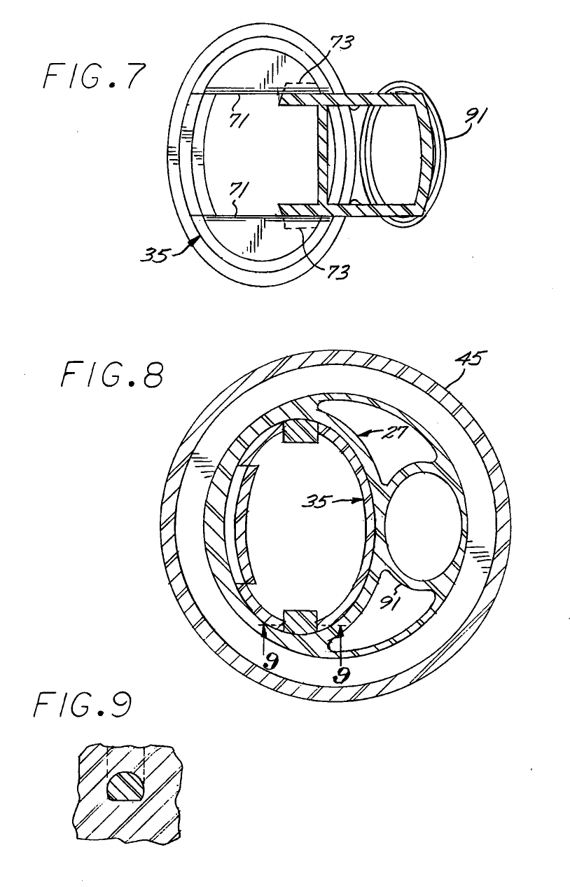

In one aspect, the device includes a stop device, generally designated 39, including a stop disk 38 which may be lifted and shifted laterally as shown in FIG. 14 to open the sleeve to receive tap water as indicated by the directional arrows 41 and, alternatively, may be shifted to its closed position shown in FIG. 5 closing the top of the sleeve.

As known by those skilled in the art, there are numerous different styles of containers, generally designated 41, which are formed with necks 43 configured with external threads or the like and which will mate with the numerous different styles of collars 45 and the like for mounting a flange or the like. Thus, it is desirable to have available filter caps which will mount to different styles and volumes of containers so that the filtering function can take place within the confines of the cap device and can be transferred from container to container for supply of filtered water from the tap to thus eliminate the necessity of purchasing bottled water in containers which are typically one use devices and then disposed.

To this end, the device of the present invention is configured with the barrel 27 formed integral with the flange and is configured in its lower extremity with a diametrically expanded disk 33 (FIG. 4) which is formed with a downwardly opening flange 51 formed with internal threads which engage with external threads formed in the holder 53 for the basket 37 to thus mount the filter basket in axial alignment with the sleeve. The disk is positioned to, when the sleeve is raised, contact the underside edge 36 of the spout (FIG. 14) to limit further upward travel and stop the top end of the sleeve in a horizontal plane above the horizontal plane of the top of the spout 91.

The wall of the sleeve 35 is formed intermediately with an exterior O-ring gland receiving an O-ring 56 which seals against the interior of the barrel 27.

The basket 37 is formed in its upper extremity with a coarse filter puck grate 57 for rapid water flow and mounts a fabric filter disk 59 in the lower extremity to trap the carbon filter puck 61.

Referring to FIGS. 3 and 5, the sleeve 35 includes in the upper extremity thereof a pair of in-turned parallel, horizontal rails 71 which engage a pair of outwardly opening channels 73 formed in the undercarriage of the stop assembly 39 for translation of the stop assembly laterally to the positions shown in FIG. 3 when the sleeve is elevated to the position shown in FIG. 14.

The stop disk 38 is formed in its periphery with an O-ring gland receiving a O-ring 79 to seal against the walls of the barrel as shown in FIG. 15.

The stop disk 38 is formed with a pair of spaced apart upwardly extending ears 81 which pivotally mount the lever arm 83 of the stopper device 39 for pivotal movement on a pivot pin 80 (FIG. 5).

Referring to FIGS. 14 and 15, the mounting flange is formed with the tubular pour spout 91 disposed adjacent the barrel configured at its top end with outlet 93 and terminating at its bottom end in the stop edge 36 (FIG. 14). The stop assembly includes a cap 42 formed with a downwardly projecting stub stop tube 85 which is configured and positioned such that when the sleeve is in its lowered position, the stop stub tube 85 will engage the opening 93 to close the spout 91.

In the exemplary embodiment the sleeve and spout are formed with oval cross sections and the stop disk 38 and the stop tube 95 formed with complimentary cross sections.

In practice, the top filtration device of the present invention will be manufactured with the collar 45 configured with fastener threads 43 to fit over the neck of standard containers to thus render the top filter device usable with readily available sports bottles and the like.

To install, the device is mounted on the top edge of the bottle neck with the mounting flange 40 sandwiched beneath the top collar between the upper lip of the collar 45 and top edge of the neck.

When it is desirable to fill the container with tap water, the user need merely grasp the distal extremity of the stop device 39 at the right hand end as viewed in FIG. 4 to snap the stop tube 85 off the opening to the pour spout 91 to pivot the lever 83 about the pivot pin 80 to the elevated position shown in FIG. 14. The user may then draw upwardly using the cap 42 as a handle to thus draw the sleeve 35 upwardly to the position shown in FIG. 14, engaging the flange with the underside 36 of the spout 91 to thereby raise the holder 53 and filter basket 37 from the docked position in the tray 29 while raising the upper end of the sleeve to its elevated position clearing the top of the barrel for the stop 38 to be shifted laterally to the position shown in FIG. 14.

The user may then apply a lateral force to the stop assembly 39 forcing the stop 38 to the right as viewed in FIG. 14 shifting it along the rails 71 (FIG. 5) to thus clear the opening to the sleeve 35 for receipt of tap water.

It will be appreciated that the rather straight axial flow through the sleeve and filter puck, will provide for relatively unobstructed high volume flow for rapid filtration advantageously, the combined cross sections of the outlets 31 in the tray is equal to or greater than the cross section of the sleeve to provide unobstructed flow through the outlets.

Concurrently, the elevation of the holder 53 will raise the O-ring 69 out of registration with the interior wall of the lower portion of the tray 29 and shift the basket upwardly clear of the outlets 31 for robust flow there-through.

Tap water may be then introduced to the sleeve 35 as indicated by the directional arrows 41 to flow downwardly to the entire cross section of the sleeve and through the robust openings in the puck grating 57, through the filter pocket and downwardly through the bottom filter 59 to flow into the interior of the tray and around the tray exiting through the openings 31 to flow unrestricted into the interior of the container 41. The container may thus be filled rapidly with a robust flow.

Closure is achieved by grasping the cap 40 of the stopper device 39 and shifting it back to the left as viewed in FIG. 14 along the rails 71 (FIG. 5) to register vertically over the sleeve 35 so the user may lower the sleeve downwardly in the barrel to thus lower the filter basket downwardly to a docking position within the tray 29 thereby registering the O-ring seal in engagement with the interior wall of the tray to isolate the filter from the water or other liquids stored within the container.

The stopper device may then be rotated clockwise as viewed in FIG. 14 to be rotated back to its horizontal position shown in FIG. 4 to thereby insert the stop tube into sealing engagement with the top of the spout. The filtered water may then be carried by the athlete or mounted on his or her bicycle or the like readily available for rehydration.

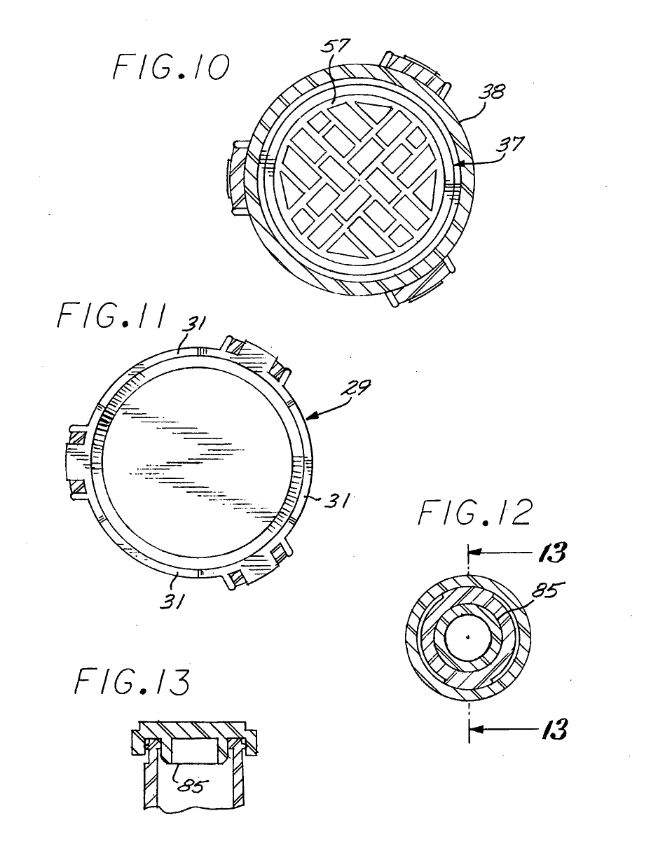

When it is desirable to drink the water, the distal end of the stop device 39 may then again be grasped to snap the distal end free of the spout 91 as shown in FIG. 9 and the container 41 inverted to provide for flow of filtered water in the direction of the directional arrows 95 to flow out the spout at a rather robust rate for quick rehydration of the athlete. Once the rehydration is completed, the container may be returned to its vertical orientation and the stopper device then rotated to its horizontal closed position shown in FIG. 4 ready for access the next time the athlete desires rehydration.

As will be appreciated by those skilled in the art, many athletes prefer supplements or flavoring which might serve to balance electrolytes and the like. In this regard, it will be undisclosed that with the sleeve device in its lowered position docking the holder in the tray 29, the seal 69 will totally isolate the filtered water in the container from the filter itself. Thus, the supplement or the like can easily be added through the pour spout 91 to be mixed with the filtered water without concern that the mixture will reach the filter and cannot contaminate or clog the filter pores or interfere with the filtration activity.

From the foregoing it will be apparent that the device of the present invention provides a convenient and inexpensive means for rapidly filtering tap water as a sport bottle is filled.

I claim:

1. A top device for a drinking bottle comprising;
a mounting flange configured with a barrel and a drinking outlet;
a sleeve received slidable in the barrel and shiftable between a filtering position and a discharge position;
a tray mounted on the bottom of the barrel and including at least one fluid outlet;
a filter basket holder mounted on the sleeve and configured for receipt in the tray; and
a seal interposed between the holder and tray.

2. The top device of claim 1 that includes:
a stopper device for, when the sleeve is in the discharge position, closing the top of the sleeve.

3. The top device of claim 1 that includes:
a stopper device including a stop disk slidably mounted to the sleeve for stopping receipt in the sleeve and slidably mounted to the sleeve for sliding laterally relative thereto;
the stopper device including an elongated lever arm pivotally mounted on one end to the stopper and formed on its opposite end with a plug for, when the stopper is in the barrel, plugging the spout.

4. The top device of claim 3 that includes:
a laterally projecting rail interposed between the sleeve and stopper device.

5. The top device of claim 3 wherein:
the sleeve includes a pair of parallel rails; and
the stopper device includes an undercarriage formed with a pair of outwardly opening channels slidably received on the respective rails.

6. The top device of claim 1 wherein:
the sleeve is formed with a predetermined cross section; and
the tray is formed with a plurality of outlets, the combined cross section of the outlets at least as great as the predetermined cross section.

7. The top device of claim 1 wherein:
the filter basket is configured with an axial flow path for flow of liquid axially therethrogh.

8. The top device of claim 1 wherein:
the stopper device is configured with a finger grasp.

9. A sports bottle top device comprising:
a housing including a barrel and a laterally disposed drinking spout;
a sleeve disposed slidably in the barrel and shiftable between respective lowered and elevated positions;
a laterally projecting rail in the sleeve;
a stopper device including a stopper slidably mounted to the rail and configured to, when the sleeve is in the lowered position, plug the barrel and when the sleeve is in the elevated position be disposed clear of the barrel for shifting laterally on the rail;
the stopper device including a stop for plugging the spout.

10. A drinking bottle top device comprising;
a housing for mounting on a bottle, the housing including a vertically elongated barrel;
a sleeve received in the barrel and shiftable between upper, open and lowered, closed positions;
a tray device mounted to the bottom of the barrel and including a cylindrical wall formed with at least one outlet;
a valve device carried from the sleeve and including a seal configured to, when the sleeve is in the closed seal against the tray to block flow through the outlet; and
a filter basket device carried from the sleeve and positioned to, when the sleeve is in the open position, provide a flow path therethrogh to the outlet.

11. The top device of claim 10 wherein:
the valve device includes an O-ring.

12. The top device of claim 10 that includes:
a stopper device coupled to the sleeve and including a stopper for plugging the barrel, the stopper device being, when the sleeve is in the open position, shiftable laterally of the barrel.

13. The drinking bottle top device of claim 10 wherein:
the sleeve includes a pair of parallel rails;
and the device including a stopper device formed with an undercarriage configured with oppositely opening channels engaging the rails for sliding there-along.

14. A sports bottle filter top to mount on a container with a storage chamber and comprising:
a housing including a mounting flange;
a barrel depending vertically from the flange and formed in its lower extremity with a first valve element;
a sleeve received slidably in the barrel and shiftable between an upper, open position and lower, closed position;
a first valve element mounted to the sleeve;
a second valve element mounted to the bottom of the sleeve and cooperating with the first valve element to, when the sleeve is in its closed position, block the flow from the chamber to the filter;
and a plug for securely plugging the barrel.

15. The sports bottle filter top of claim 14 that includes:
a pour spout depending from the flange adjacent the barrel;
a cap device carried from the plug and slidably shiftable to cover the spout.

16. Sports bottle filter top of claim 15 where:
the cap device includes a lever arm peripherally connected to one end to the plug and carrying the cap on the free end.

17. The sports bottle filter top of claim 14 wherein:
the second valve element is in the form of an upwardly opening cup configured with outlets spaced about the periphery thereof

18. A sports bottle filter top to mount on a container and comprising:
a mounting flange for setting on the top edge of the mouth of the container;
a vertically extending barrel depending downwardly from the mounting flange;
a pour spout on the flange adjacent the barrel;
a sleeve received slidably in the barrel and projecting downwardly therein to, at the lower extremity, expand outwardly to form a horizontal flange for abutting the bottom end of the spout to limit upward travel of the sleeve;
a cup shaped tray carried by the lower extremity of the sleeve and configured with outwardly opening outlets;
a basket holder mounted to the flange and shaped to be complementally received in the tray;
a seal mounted to the exterior of the holder for sealing engagement with the tray;
a filter basket received in the holder and including on the upper extremity a coarse grate for flow of fluid there-through and including on the lower extremity a fiber filter;
activated carbon formed as a filter puck received between the grate and the fiber filter;
the upper extremity of the sleeve including a pair of parallel rails;
a stopper device for mounting to the sleeve and including an undercarriage formed with laterally outwardly opening channels engaging the respective rails, the stopper device including a stopper disk for, when the sleeve is lowered for selectively plugging the opening to the sleeve;
a stop device pivotally carried from the disk and including a lever arm formed at its distal extremity with a plug for, when the disk is disposed in the sleeve, and the sleeve in its lowered position, plugging the spout.
